(19) United States
(12) Patent Application Publication
(10) Pub. No.: US 2018/0046558 A1
(43) Pub. Date: Feb. 15, 2018

(54) INFORMATION PROCESSING APPARATUS, CONTROLLING DEVICE, AND NON-TRANSITORY COMPUTER-READABLE RECORDING MEDIUM HAVING STORED THEREIN PROGRAM

(71) Applicant: FUJITSU LIMITED, Kawasaki-shi (JP)

(72) Inventor: Tomohiro Kobayashi, Yokohama (JP)

(73) Assignee: FUJITSU LIMITED, Kawasaki-shi (JP)

(21) Appl. No.: 15/663,864

(22) Filed: Jul. 31, 2017

(30) Foreign Application Priority Data
Aug. 10, 2016 (JP) 2016-157674

(51) Int. Cl. G06F 11/20

(52) U.S. Cl. CPC G06F 11/2092; G06F 2201/805

(57) ABSTRACT

An information processing apparatus includes a plurality of partitions, a first controlling device belonging to a first partition among the plurality of partitions, and a second controlling device belonging to a second partition among the plurality of partitions. The first controlling device includes a first processor configured to control the plurality of partitions. The second controlling device includes a second processor configured to control the second partition.

### CROSS-REFERENCE TO RELATED APPLICATION

This application is based upon and claims the benefit of priority of the prior Japanese Patent application No. 2016-157674, filed on Aug. 10, 2016, the entire contents of which are incorporated herein by reference.

### FIELD

The embodiment discussed herein is directed to an information processing apparatus, a controlling device, and a non-transitory computer-readable recording medium having stored therein a program.

### BACKGROUND

In a server device adopting a Building Block (BB) scheme, the system is formed of multiple BB casings. A Service Processor (SP) is installed in each BB casing. Each SP controls and monitors the hardware of the local casing, but one of the SPs collectively controls the entire system. The SP that controls the entire system may be referred to as a master SP and an SP that operates in response to an instruction from the master SP may be referred to as a slave SP.

The user arbitrarily partitions a BB-scheme system according to the operating condition. The user can power on and off each individual physical partition (hereinafter, simply referred to as “partition”).

On the master SP, a program (which may also be referred to as a “sequence process”) that controls a process sequence such as powering on and off each partition operates. On each slave SP, a program (which may also be referred to a “process of hardware controlling in a BB”) that directly controls the hardware in the local BB casing operates.

For example, when the user makes an instruction to power on the partition #0, the sequence process of the master SP that receives the instruction to power on and instructs the process of hardware control in a BB of the slave SP to carry out a powering-on procedure. In this case, the target of the powering-on instruction is a BB casing belonging to the partition #0. As the above, the master SP has a function of managing the sequence of hardware control in a BB of each BB casing.

The sequence process waits (which may also be referred to “synchronization”) until it obtains the result of the instruction issued to the slave SPs. When the results of the instruction are received from all the slave SPs (in other words, “synchronizations with all the slave SPs are established”), the sequence process carries out a procedure of the next entry.
Patent Literature 1: Japanese Laid-Open Patent Publication No. 61-58038
Patent Literature 2: Japanese Laid-Open Patent Publication No. 59-121415

In the above system, the master SP issues process instructions to a slave SP one for each process, and is annoyed by load caused by the consequent frequent communication. The load on the master SP caused from an increase in communication amount to monitor and control each slave SP also increases, which may have a possibility of delaying processes.

### SUMMARY

According to an aspect of an embodiment, an information processing apparatus includes a plurality of partitions. The information processing apparatus includes a first controlling device belonging to a first partition among the plurality of partitions, and a second controlling device belonging to a second partition among the plurality of partitions. The first controlling device comprises a first processor configured to control the plurality of partitions, and the second controlling device includes a second processor configured to control the second partition.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

### BRIEF DESCRIPTION OF DRAWINGS

FIG. 1 is a diagram illustrating partition control in an information processing apparatus of a related-art example;

FIG. 2 is a diagram illustrating a waiting process in the partition control of FIG. 1;

FIG. 3 is a block diagram schematically illustrating a hardware configuration of an information processing apparatus according to an embodiment;

FIG. 4 is a block diagram schematically illustrating a functional configuration of an SP of FIG. 3;

FIG. 5 is a diagram illustrating partition control in the information processing apparatus of FIG. 3;

FIG. 6 is a diagram illustrating a waiting process in partition control of FIG. 5;

FIG. 7 is a block diagram schematically illustrating a software configuration of the information processing apparatus of FIG. 3;

FIG. 8 is a diagram illustrating an example of configuration information of FIG. 7 in a table form;

FIG. 9 is a diagram illustrating an example of a partition configuration represented by the configuration information of FIG. 8;

FIG. 10 is a flow diagram illustrating an operation of determining a partition master in the information processing apparatus of FIG. 3;

FIG. 11 is a flow diagram illustrating an operation of setting a partition master in the information processing apparatus of FIG. 3; and

FIG. 12 is a flow diagram illustrating a procedure of powering on in the information processing apparatus of FIG. 3.

### DESCRIPTION OF EMBODIMENTS

Hereinafter, description will now be made in relation to an embodiment with reference to the accompanying drawings. The following embodiment is exemplary, so there is no intention to exclude applications of various modifications and techniques not explicitly described in the following description to the embodiment. Various changes and modifications to the embodiment can be suggested without departing from the scope of the embodiment.

The accompanying drawings of the embodiment do not limit that the elements appearing therein are only provided but can include additional functions.

Throughout the drawings, like reference numbers designate the same or similar parts and elements, so repetitious description will be omitted here.

### (A) Related-Art Example

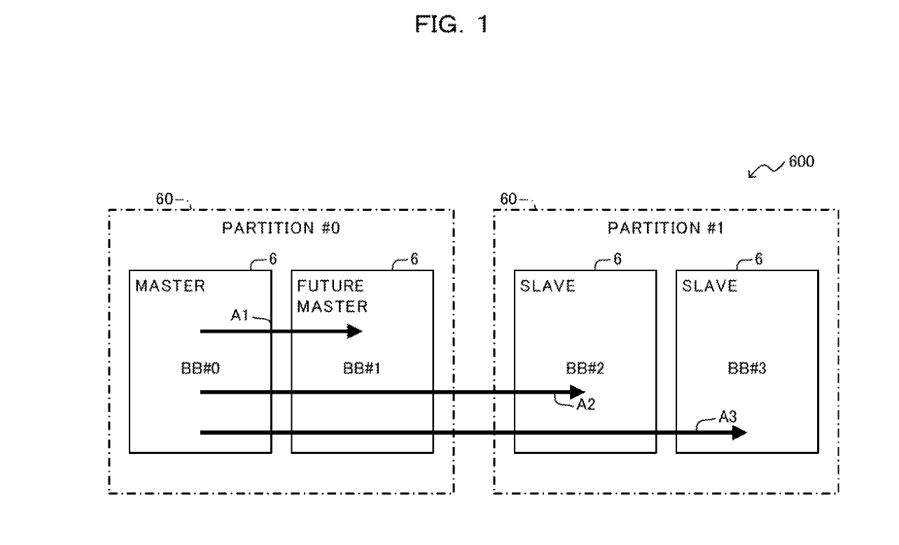

FIG. 1 is a diagram illustrating partition control in an information processing apparatus 600 of a related example.

The information processing apparatus 600 of FIG. 1 includes multiple (four in the illustrated example) BBs 6 (which may also referred to as BB #0 to BB #3)

Each BB 6 belongs to one of multiple (two in the example of FIG. 1) partitions 60. In the example of FIG. 1, the BB #0 and the BB #1 belong to the partition #0, and the BB #2 and the BB #3 belong to the partition #1. A process, such as powering on a BB 6, performed on a BB 6 may be carried out in a unit of a partition 60.

Each BB 6 functions as one of a master, a future master, and a slave. In the example of FIG. 1, the BB #0 functions as a master, the BB #1 functions as a future master, and the BB #2 and the BB #3 function as slaves.

The master manages the other BBs 6 included in the information processing apparatus 600. The future master takes over the function of the master in cases where abnormality such as a failure occurs in the master. This means that the information processing apparatus 600 has master-redundant system. A slave functions under control of the master.

Hereinafter, a BB 6 that functions as a master is sometimes referred to as a master BB 6 (in the example of FIG. 1, “master BB #0”). A BB 6 that functions as a future master is sometimes referred to as a future master BB 6 (in the example of FIG. 1, “future master BB #1”). A BB 6 that functions as a slave is sometimes referred to as a slave BB 6 (in the example of FIG. 1, “slave BB #2 or #3”)

In the example of FIG. 1, the sequence of the master BB #0 issues instruction action to carry out a reset sequence to the daemons of the future master BB #1 and the slave BBs #2 and #3 (see Arrows A1-A3). This activates the BBs #1-#3.

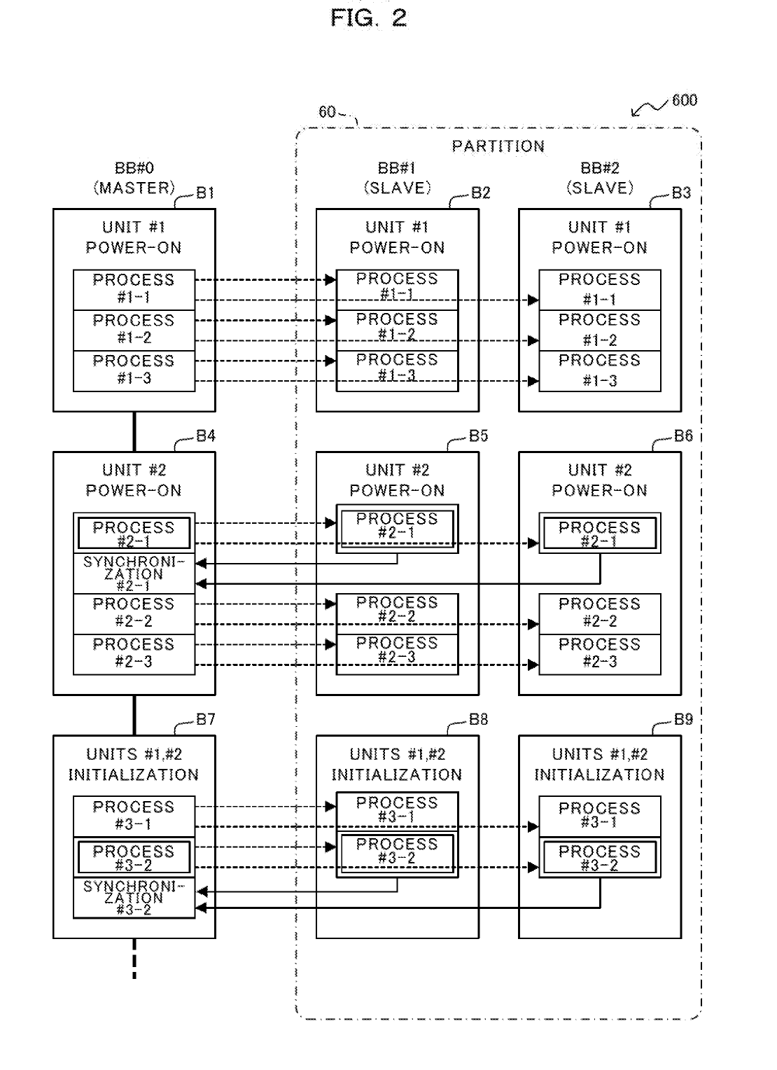

FIG. 2 is a diagram illustrating a waiting process in the partition control of FIG. 1.

The information processing apparatus 600 of FIG. 2 includes the BB #0, the BB #1, and the BB #2. The BB #0 functions as the master. The BB #1 and BB #2 function as slaves and belongs to the same partition 60. The BB #1 and the BB #2 each include non-illustrated units #1 and #2.

In the example of FIG. 2, in a process of powering on the unit #1, the master BB #0 instructs the slave BBs #1 and #2 to carry out Processes #1-1, #1-2, and #1-3 (see reference number B1). Here, the unit of the procedure represented by the process #1-1, for example, may also be referred to as an “action”.

The slave BB #1 and the BB #2 carry out Processes #1-1, #1-2, and #1-3 in response to the instruction from the master BB #0 (see reference numbers B2 and B3)

In a process of powering on the unit #2, the master BB #0 instructs the slave BBs #1 and #2 to carry out Processes #2-1, #2-2, and #2-3 (see reference number B4)

The slave BBs #1 and #2 carry out Processes #2-1, #2-2, and #2-3 in response to the instruction from the master BB #0 (see reference numbers B5 and B6)

Here, Process #2-1 illustrated in a double-line frame is synchronized between the slave BB #1 and the slave BB #2. This means that, in cases where Process #2-1 is completed in the slave BB #1 and slave BB #2, the master BB #0 carries out Synchronization #2-1. After Synchronization #2-1 is completed, executions of Processes #2-2 and #2-3 in the master BB #0 are instructed and Processes #2-2 and #2-3 are executed in the slave BBs #1 and #2.

In the initialization of the units #1 and #2, the master BB #0 instructs the slave BBs #1 and #2 to carry out Process #3-1 and #3-2 (see reference number B7)

The slave BB #1 and BB #2 carry out Processes #3-1 and #3-2 in response to the instruction from the master BB #0 (see reference numbers B8 and B9).

Here, Process #3-2 illustrated in a double-line frame is synchronized between the slave BB #1 and the slave BB #2. This means that, in cases where Process #3-2 is completed in the slave BB #1 and slave BB #2, the master BB #0 carries out Synchronization #3-2. Then, when Synchronization #3-2 is completed, initialization of the unit #1 and the unit #2 is completed.

In other words, the sequence process waits (which may also be referred to as “synchronizes”) until the result of an instruction issued to each BB 6 is obtained. When receiving the notification of the result from all the slave BBs 6 (i.e., when the “synchronization is established”), the sequence process makes an arrangement for the next entry.

Since the hardware control of a BB 6 is a distributed process carrying out the hardware control process in a BB for each slave BB 6, the hardware control may have time differences (in other words, “time lag”) in some states of each BB 6. Some types of procedure of the hardware control sequence (e.g., setting for tuning of the quality of the transmission path between LSIs) synchronizes the respective states of the BBs 6 with one another. Here, hardware control may also be referred to as a Large-Scale Integration (LSI) control.

For the above, the master BB 6 has a function of managing the execution of the hardware control sequence on each BB 6 in the sequence process. However, in cases where synchronization is carried out in all the procedures, it takes excessively long time to execute the hardware control sequence. As a solution to the above, the sequence program manages whether the synchronization is needed or not needed.

In the information processing apparatus 600 of FIGS. 1 and 2, the master BB 6 issues process instructions to a slave BB 6 for each process, and is annoyed by load caused by the consequent frequent communication. The load on the master BB 6 caused from increase in communication amount to monitor and control each slave BB 6 also increases, which may have a possibility of delaying processes.

The master BB 6 retaining the sequence table and conducting powering-on control on the partition 60 means that the entire information processing apparatus 600 uses a common sequence table. Unfortunately, this case is not able to deal with a system configuration in which the hardware architecture is different with BBs #6. In cases where the information processing apparatus 600 includes BBs 6 having different hardware architectures, the information processing apparatus 600 is not allowed to have different design for powering-on and powering-off procedures with BB 6.

### (B) Embodiment

(B-1) System Configuration

An information processing apparatus 100 of the present embodiment has the following functional configuration in order to efficiently controls each partition 10.

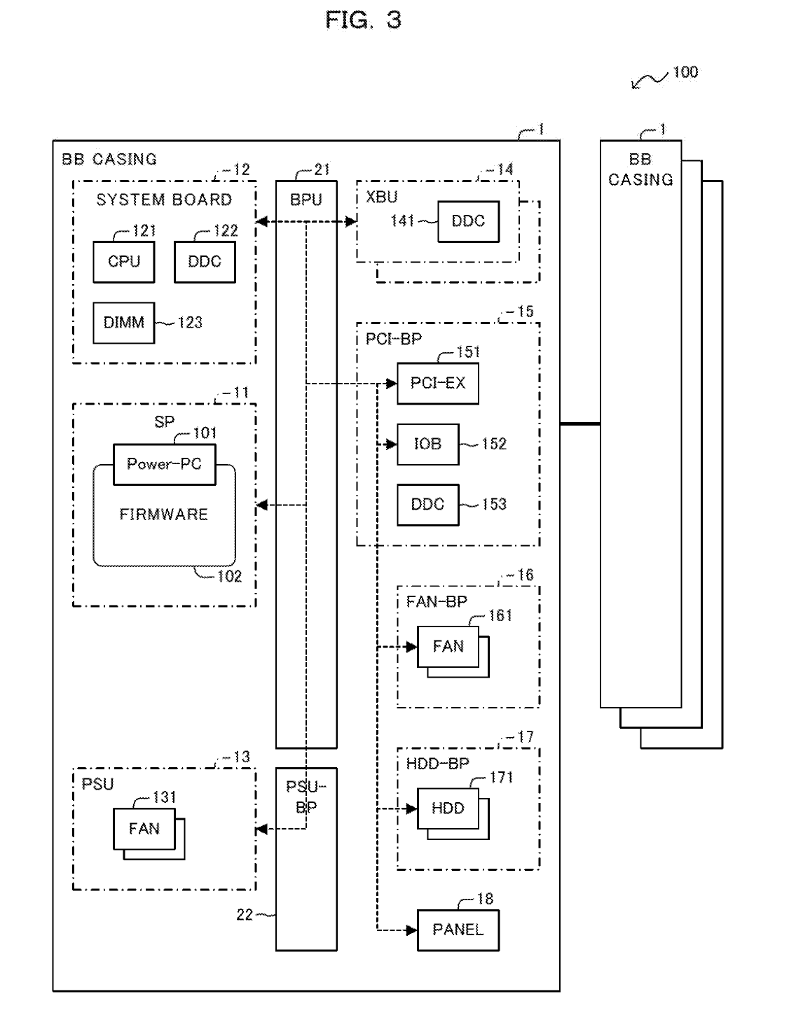

FIG. 3 is a block diagram schematically illustrating the hardware configuration of the information processing apparatus 100 of the present embodiment.

The information processing apparatus 100 of FIG. 3 includes multiple BB casings (hereinafter simply referred to as “BBs”) 1. The BBs 1 are communicably connected to one another by means of Peripheral Component Interconnect (PCI), for example.

Each BB 1 includes an SP 11, a system board 12, a Power Supply Unit (PSU) 13, a Crossbar Unit (XBU) 14, a PCI-Back Plane (BP) 15, a FAN-BP 16, a Hard Disk Drive (HDD)-BP 17, a panel 18, a Back Plane Unit (BPU) 21, and a PSU-BP 22.

The BPU 21 relays communication among the SP 11, the system board 12, the XBU 14, the PCI-BP 15, the FAN-BP 16, the HDD-BP 17, the panel 18, and the PSU-BP 22. The PSU-BP 22 relays communication among the PSU 13 and BPU 21.

The system board 12 includes a Central Processing Unit (CPU) 121, a Digital-Digital Converter (DDC) 122, and a Dual Inline Memory Module (DIMM) 123.

The CPU 121 is a processor device that carries out various controls and calculations, and achieves various functions through executing the Operating System (OS) and programs stored in the DIMM 123. The DDC 122 supplies electric power to units installed in the system board 12. The DIMM 123 is used as a primary storing memory or a working memory.

The PSU 13 supplies electric power to units in the BB 1, and includes multiple FANs 131. The FANs 131 are air-cooling fans to cool the inside of the PSU 13.

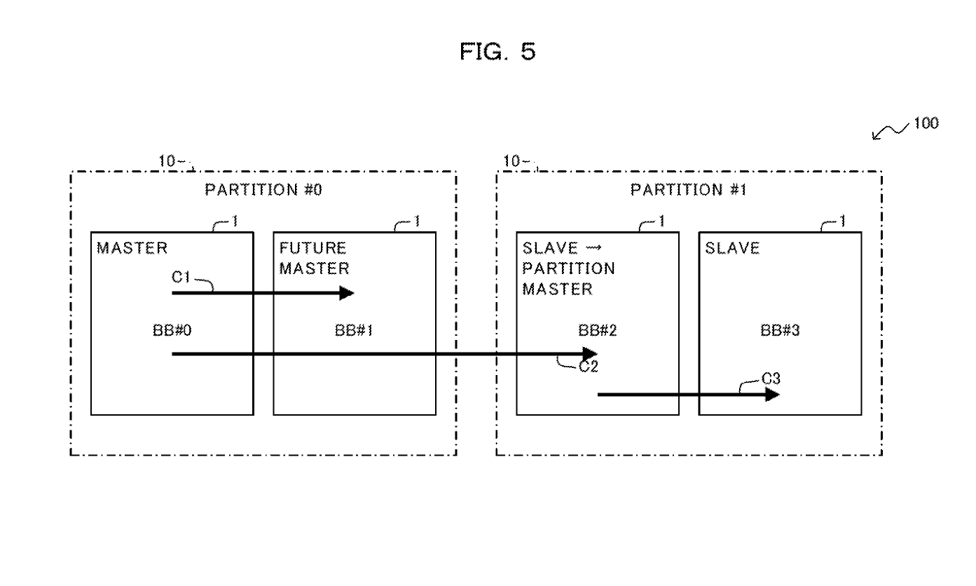

The XBU 14 logically switches the physical partitions (hereinafter simply referred to as “partitions”) 10 (which will be detailed below by referring to FIG. 5, for example) of multiple BBs 1 installed in the information processing apparatus 100, and includes the DDC 141. The DDC 141 supplies electric power to units (not illustrated) installed in the XBU 14.

The PCI-BP 15 includes a PCI-Express (PCI-EX) 151, an Input Output Board (IOB) 152, and a DDC 153. The PCI-EX 151 communicates with the other BBs 1 in conformity to the standard of PCI express. The IOB 152 communicates with the other BBs 1. The DDC 153 supplies electronic power to units installed in the PCI-BP 15.

The FAN-BP 16 includes multiple FANs 161. The FANs 161 is an air-cooling fan that cools inside of the BB 1.

The panel 18 displays information to be notified to the operator of the information processing apparatus 100.

The SP 11 includes a Performance optimization with enhanced RISC-Performance Computing (Power-PC) 101 as an example of a microprocessor. The term “RISC” is an abbreviation for Reduced Instruction Set Computer. The Power-PC 101 carries out the partition control as to be detailed below with reference to FIG. 5, for example, by executing firmware 102.

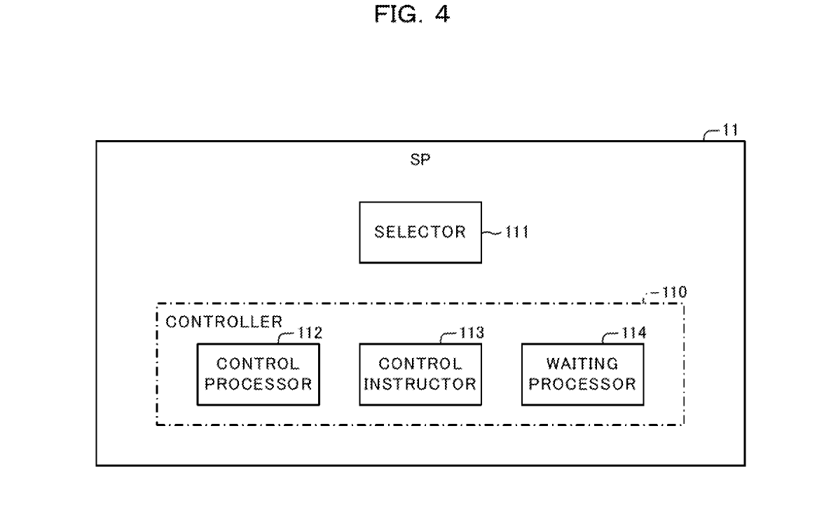

FIG. 4 is a block diagram schematically illustrating the functional configuration of the SP 11 in FIG. 3.

An exemplary SP 11 is a processor device that carries out various controls and calculation, and achieves various functions through executing the OS and programs stored in a memory (not illustrated). Accordingly, the SP 11 may function as a selector 111 and a controller 110, as illustrated in FIG. 4. Alternatively, the functions as the selector 111 and the controller 110 may be included in the Power-PC 101 of the SP 11 illustrated in FIG. 3.

The program to achieve the functions as the selector 111 and the controller 110 may be provided in the form of being stored in a non-transitory computer readable recording medium such as a flexible disk, a CD (CD-ROM, CD-R, CD-RW), a DVD (DVD-ROM, DVD-RAM, DVD-R, DVD+R, DVD-RW, DVD+RW, HD DVD), a Blu-ray disc, a magnetic disk, an optical disk, and a magneto-optical disk. A computer (in the present embodiment, the SP 11) may read the program from the above recording medium, using a non-illustrated reading device, and forwards the read program to an internal recording device or an external recording device where the read program is stored for future use. The program may be recorded in a memory device (recording medium) such as a magnetic disk, an optical disk, and a magneto-optical disk, and may be provided to a computer from the memory device via a communication path.

In achieving the functions as the selector 111 and the controller 110, the program stored in an internal memory device (in the present embodiment, the non-illustrated memory) may be executed by the computer (in the present embodiment, the SP 11). Alternatively, the computer may read the program stored in a recording medium and execute the read program.

The functions of the selector 111 and the controller 110 will now be described with reference to FIG. 5.

FIG. 5 is a diagram illustrating the partition control in the information processing apparatus 100 in FIG. 3.

The information processing apparatus 100 of FIG. 5 includes multiple (four in the illustrated example) BBs 1 (which may also be referred to as BB #0 to BB #3).

Each BB 1 belongs to one of the multiple (two in the example of FIG. 5) partitions 10. In the example of FIG. 5, the BB #0 and the BB #1 belong to the partition #0, and the BB #2 and the BB #3 belong to the partition #1. A process, such as powering on, performed on a BB 1 may be carried out in a unit of a partition 10.

Similarly to the example of FIG. 1, in the initial state of the example of FIG. 5, the BB #0 functions as a master, the BB #1 functions as a future master, and the BBs #2 and #3 function as slaves.

The selector 111 of FIG. 4 selects a BB 1 that is to be caused to function as a partition master among the multiple BBs 1 in the partition #1, to which the master BB 1 does not belong. A partition master manages one or more BBs 1 belonging to the same partition 10.

As a first condition, the selector 111 may select a BB 1 that does not functioning as a future master as the partition master. As a second condition, the selector 111 may select a BB 1 not having a problem, such as a failure, as the partition master. Further, in cases where two or more BBs 1 satisfying the both first and second conditions are present in a single partition 10, the selector 111 may select the BB 1 having a minimum identifier (ID) as the partition master. In contrast, in cases where no BB 1 satisfying the both first and second conditions is present in a partition 10, a BB 1 satisfying the second condition and not satisfying the first condition may be selected as the partition master.

In cases where three or more partitions 10 are included in the information processing apparatus 100, the selector 111 may select a partition master for each partition to which the master BB 1 does not belong.

Accordingly, in the example in FIG. 5, the BB #0 functions as the master, the BB #1 functions as the future master, the BB #2 functions as the partition master, and the BB #3 functions as a slave.

Hereinafter, the BB 1 functioning as the partition master is sometimes referred to as the partition master BB 1 (in the example of FIG. 5, the “partition master BB #2”). The master BB 1 is an example of the first controlling device and the partition master BB 1 is an example of the second controlling device.

In cases where a failure occurs in a BB 1 in one of partition 10 and consequently the BB 1 becomes unable to continue its operation while the system is operating, the BB 1 having the failure is isolated from the partition configuration and is fallen back, and then the partition 10 is restarted. At that time, when the BB 1 having the failure is the partition master BB 1, the selector 111 changes the partition master BB1.

The controller 110 of FIG. 4 controls various processes, such as powering-on of a BB 1. The controller 110 of the master BB 1 is an example of the first processor, and controls all the BBs 1 belonging to the multiple partitions 10 included in the information processing apparatus 100. The controller 110 of the partition master BB 1 is an example of the second processor, and controls all the BBs 1 belonging to the local partition 10, to which the partition master BB1 belongs to. The controllers 110 of the future master BB 1 and the slave BB 1 controls the respective local BBs 1.

As illustrated in FIG. 4, the controller 110 functions as a control processor 112, a control instructor 113, and a waiting processor 114.

The functions as the control processor 112 and the waiting processor 114 may be to be effective in the master BB 1, the partition master BB 1, the future master BB 1, and the slave BB 1 (i.e., all the BBs 1 included in the information processing apparatus 100).

The function as the control instructor 113 may be made effective in the master BB 1 and the partition master BB 1.

The control processor 112 carries out various controls, such as, powering-on control, in the local BB 1.

The control instructor 113 issues instructions for various controls, such as powering-on control, to the other BBs 1.

The control instructor 113 of the master BB 1 issues instructions (which may also be referred to “control instructions”) for various controls, such as powering-on control, to each BB 1 belonging to the same partition 10 as the master BB 1 and the partition master BB 1 belonging to a different partition 10 from that the master BB 1 belongs to.

The control instructor 113 of the partition master BB 1 issues instructions for various controls, such as powering-on control, to each BB 1 belonging to the same partition 10 as the partition master BB 1.

In response to a predetermined control instruction among control instructions issued from the local control instructor 113 of a BB 1, the waiting processor 114 waits for (in other words, synchronizes) the completion of a control performed in on one or more BBs 1 of the destination of the predetermined control instruction.

The waiting processor 114 of the master BB 1 receives information (which may also be referred to as “control completion information”) indicating that control performed in response to a control instruction issued from the control instructor 113 of the master BB 1 is completed from each of the BBs 1 of the destination of the control instruction. The waiting processor 114 of the master BB 1 permits the control processor 112 of the master BB 1 to carry out the next control in the sequence, and also permits the control instructor 113 of the master BB 1 to issue the next control instruction of the sequence.

The waiting processor 114 of the partition master BB 1 receives the control completion information from each BB 1 of the destinations of the control instruction issued from the control instructor 113 of the partition master BB 1. Then, the waiting processor 114 of the partition master BB 1 permits the control processor 112 of the partition master BB 1 to carry out the next control in the sequence, and also permits the control instructor 113 of the partition master BB 1 to issue the next control instruction in the sequence.

The waiting processor 114 of the partition master BB 1 is an example of the second processor. When the control in the partition master BB 1 is completed and the waiting processor 114 of the partition master BB 1 receives the control completion information from each slave BB 1 of the destination of the control instruction issued from the control instructor 113, the waiting processor 114 of the partition master BB 1 notifies the master BB 1 of control completion information. The control completion information transmitted from a slave BB 1 indicates that the control performed in response to a control instruction is completed in the same slave BB 1. The control completion information transmitted from the partition master BB 1 represents that the control performed in response to the control instruction issued from the master BB 1 is completed in the partition 10 that the partition master BB 1 belongs to.

When the control is completed in a slave BB 1, the waiting processor 114 of the slave BB 1 notifies the partition master BB 1 of control completion information.

In the example in FIG. 5, the sequence of the master BB #0 issues an instruction action for executing reset of the sequence to the respective daemons of the future master BB #1 and the partition master BB #2 (see arrows C1 and C2). This consequently activates the BB #1 and the BB #2.

Upon receipt of the instruction action for executing reset of the sequence from the master BB #0, the partition master #2 issues the instruction action for executing reset of the sequence to the daemon of the slave BB #3 (see arrow C3). This consequently activates the BB #3.

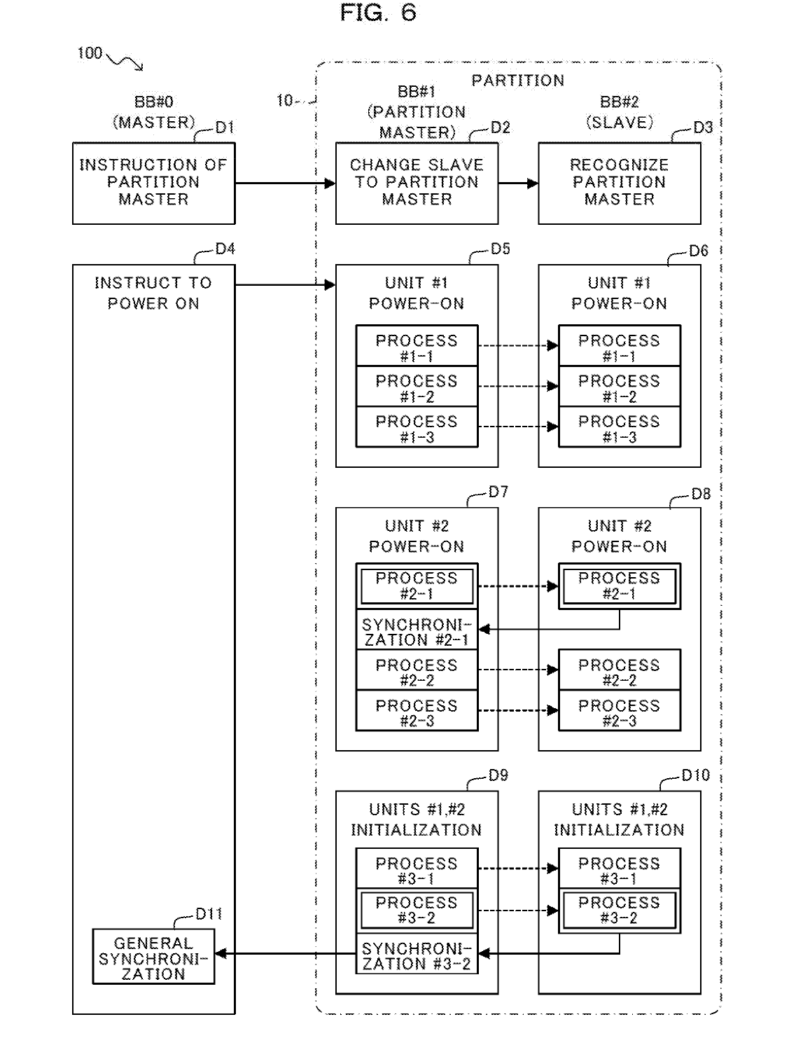

FIG. 6 is a diagram illustrating a waiting process in the partition control in FIG. 5.

The information processing apparatus 100 illustrated in FIG. 6 includes the BB #0, the BB #1, and BB #2. The BB #1 and BB #2 belong to the same partition 10, and each include non-illustrated units #1 and #2.

The selector 111 of the master BB #0 selects the BB #1 as the partition master of the partition to which the BB #1 and BB #2 belong. Then, the master BB #0 issues an assignment to the partition master to the BB #1 (see reference number D1).

Upon receipt of the assignment to the partition master from the master BB #0, the BB #1 changes the own setting of the BB #1 from a slave to the partition master (see reference number D2). Then, the BB #1 notifies the BB #2 of information (which may also be referred to as “information of partition master change”) representing that the BB #1 has been changed to the partition master.

Upon receipt of the information of partition master change from the BB #1, the BB #2 recognizes that the BB #1 has been changed to the partition master (see reference number D3)

Through the process denoted by the above reference numbers D1-D3, the BB #0 comes to function as the master, the BB #1 comes to function as the partition master, and the BB #2 comes to function as a slave.

The control instructor 113 of the master BB #0 issues an instruction to power on the units #1 and #2 to the partition master BB #1 (see reference number D4).

In response to the instruction to power on the unit from the master BB #0, the control processor 112 of the partition master BB #1 carries out Processes #1-1, #1-2, and #1-3 for powering on the unit #1 in the partition master BB #1 (see reference number D5). The control instructor 113 of the partition master BB #1 issues an instruction to power on the unit #1 to the slave BB #2.

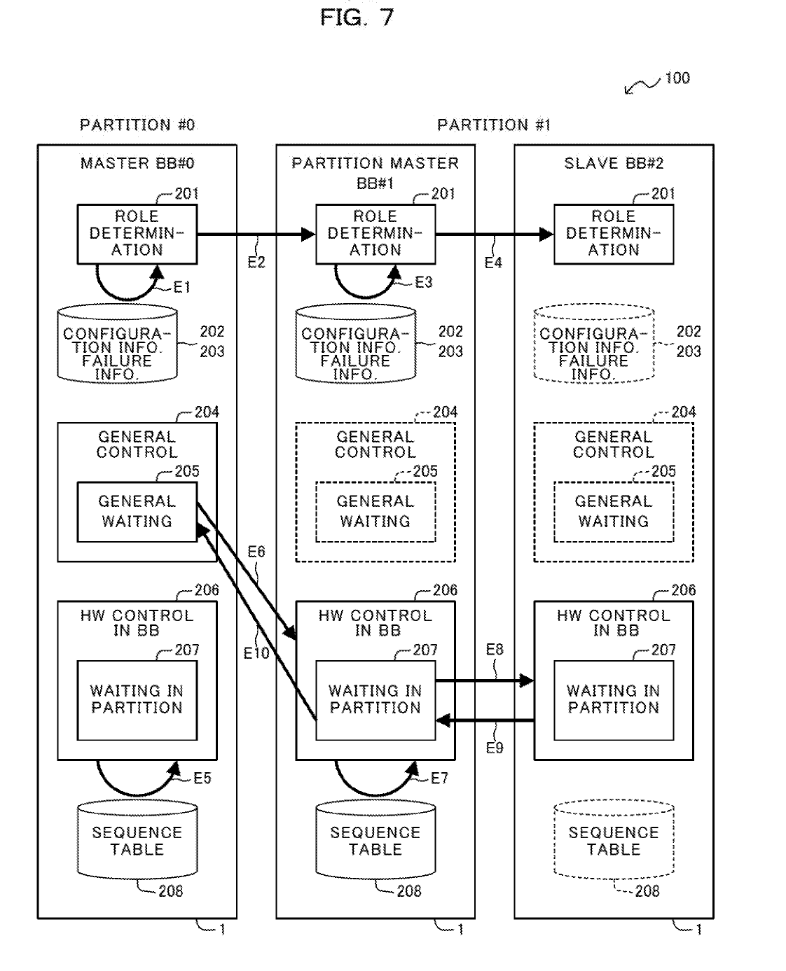

A unit of the procedure represented by, for example, Process #1-1 may be referred to as an “action”. Multiple actions included in various controls such as powering on may be stored in a sequence table 208, which will be described below with reference to FIG. 7.

In response to the instruction to power on the unit from the partition master BB #1, the control processor 112 of the slave BB #2 carries out Processes #1-1, #1-2, and #1-3 for powering on the unit #1 in the BB #2 (see reference number D6)

In response to the instruction to power on the unit from the master BB #0, the control processor 112 of the partition master BB #1 carries out Processes #2-1, #2-2, and #2-3 for powering on the unit #2 in the BB #1 (see reference number D7). The control instructor 113 of the partition master BB #1 issues an instruction for powering on the unit #2 to the slave BB #2.

In response to the instruction for powering on from the partition master BB #1, the control processor 112 of the slave BB #2 carries out Processes #2-1, #2-2, and #2-3 for powering on the unit #2 in the BB #1 (see reference number D8)

Here, Process #2-1 illustrated in a double-line frame is synchronized between the partition master BB #1 and the slave BB #2. This means that, in cases where Process #2-1 is completed in the partition master BB #1 and the slave BB #2, the waiting processor 114 of the partition master BB #1 carries out Synchronization #2-1. After Synchronization #2-1 is completed, the partition master BB #1 executes Processes #2-2 and #2-3, and instructs the slave BB #2 to execute Processes #2-2 and #2-3. Then, the slave BB #2 executes Processes #2-2 and #2-3.

In response to the instruction for powering on from the master BB #0, the control processor 112 of the partition master BB #1 carries out Processes #3-1 and #3-2 for an initialization of the units #1 and #2 in the partition master BB #1 (see reference number D9). The control instructor 113 of the partition master BB #1 issues an instruction for initialization of the units #1 and #2 to the slave BB #2.

In response to the instruction for initialization from the partition master BB #1, the control processor 112 of the slave BB #2 carries out Processes #3-1 and #3-2 for initialization of the units #1 and #2 in the slave BB #2 (see reference number D10).

Here, Process #3-2 illustrated in a double-line frame is synchronized between the partition master BB #1 and the slave BB #2. This means that, in cases where Process #3-2 is completed in the partition master BB #1 and the slave BB #2, the waiting processor 114 of the partition master BB #1 carries out Synchronization #3-2. After Synchronization #3-2 is completed, the waiting processor 114 of the partition master BB #1 notifies the master BB #0 of control completion information indicating that control of powering on in the partition 10 that the partition master BB #1 belongs to is completed.

The waiting processor 114 of the master BB #0 receives the control completion information notified from the partition master BB #1 and recognizes that the general synchronization of the information processing apparatus 100 has been completed (see reference number D11).

FIG. 7 is a block diagram schematically illustrating the software configuration of the information processing apparatus 100 in FIG. 3.

The information processing apparatus 100 in FIG. 7 includes the BB #0, the BB #1, and BB #2. The BB #0 belongs to the partition #0, and the BB #1 and the BB #2 belong to the partition #1. In FIG. 7, blocks illustrated with broken lines represent unused functions.

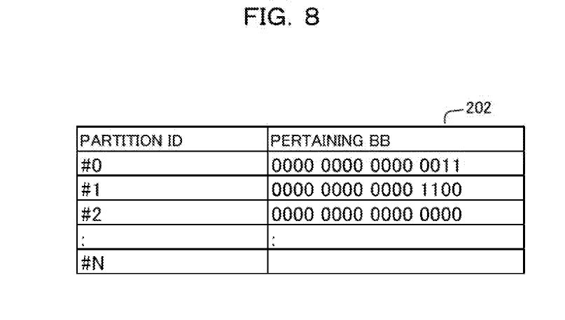

In a role determination 201, the master BB #0 selects the BB #1 as the partition master of the partition # by referring to configuration information 202 and failure information 203 (see reference number E1). The configuration information 202 may be stored in the HDD 171 illustrated in FIG. 3, for example, and may contain information of BBs 1 belonging to each partition 10. The configuration information 202 will be detailed below with reference to FIG. 8. The failure information 203 may be stored in the HDD 171 illustrated in FIG. 3, for example, and may contain information of a BB 1 having a problem such as a failure. The master BB #0 issues assignment to a partition master to the BB #1 (see reference number E2).

Upon the receipt of the assignment to a partition master from the master BB #0 during the role determination 201, the BB #1 changes the own setting from a slave to the partition master. Then the BB #1 specifies the remaining BB(s) 1 belonging to the partition #1 by referring to the configuration information 202, and notifies the BB #2 of the information of partition master change (see reference numbers E3 and E4). The information of partition master change may contain information indicating that the partition master has been set or changed and may also contain the information to specify the partition master BB 1.

In the role determination 201, the BB #2 receives the information of partition master change from the BB #1 and then recognizes that the BB #1 has been changed to the partition master.

Through the above role determination 201 involved by the BBs #0-#2, the BB #0 comes to function as the master, the BB #1 comes to function as the partition master, and the BB #2 comes to function as the slave.

In hardware (HW) control 206 in a BB, the master BB #0 carries out waiting 207 in the partition #0 by referring to a sequence table 208 (see reference number E5). The information about the sequence table 208 may be stored in the HDD 171 illustrated in FIG. 3, for example, and may contain information of the contents and the sequence of controls to be carried out in the BBs 1 in each partition 10.

In a general control 204, the master BB #0 carries out a process of general waiting 205. The master BB #0 issues a control instruction for powering on, for example, to the partition master BB #1 (see reference number E6).

In the hardware control 206 in the BB, the partition master BB #1 carries out the waiting 207 in the partition #1 by referring to a sequence table 208 (see reference number E7). The partition master BB #1 issues a control instruction for powering on, for example, to the slave #2 (see reference number E8).

In the hardware control in a BB, the slave BB #2 carries out a process of waiting 207 in the partition in regard of the BB #2. Upon completion of the control, the BB #2 notifies the partition master BB #1 of control completion information (see reference number E9)

When the partition master BB #1 receives the control completion information from the slave BB #2, the intra-partition waiting 207 in the partition #1 is completed. Then, the partition master BB #1 notifies the master BB #0 of the control completion information (see reference number E10).

When the master BB #0 receives the control information from the partition master BB #1, the general waiting 205 is completed.

FIG. 8 is an example of the table form of the configuration information 202 in FIG. 7.

In the configuration information 202, the “partition ID (identifier)” that specifies a partition 10 is associated with a “pertaining BB” representing BBs 1 belonging to the partition 10. The “pertaining BB” may be represented in a binary number.

The example in FIG. 8 indicates that: the BB #0 and the BB #1 belong to the partition #0, the BB #2 and the BB #3 belong to the partition #1, and no BB 1 belongs to the partition #2.

The configuration information 202 retained in the information processing apparatus 100 allows each BB 1 to recognize partitions 10 to which another BB 1 belongs, so that the partition master BB 1 can be selected with ease.

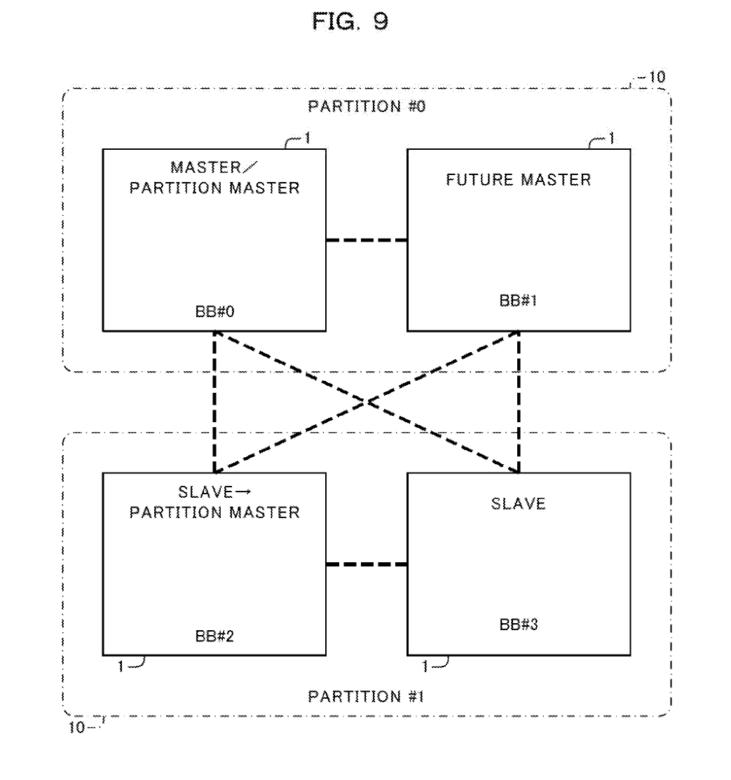

FIG. 9 is a diagram illustrating an example of a partition configuration denoted by the configuration information 202 in FIG. 8.

In the example of FIG. 9, the master BB #0 and the future master BB #1 belong to the partition #0, and the partition master BB #2 and the slave BB #3 belong to the partition #1.

The master BB #0 also functions as the partition master to control the BBs 1 belonging to the partition #0. The partition master BB #2 has functioned as a slave in the initial state and is selected as the partition master by the selector 111 of the master BB #0.

(B-2) Operation

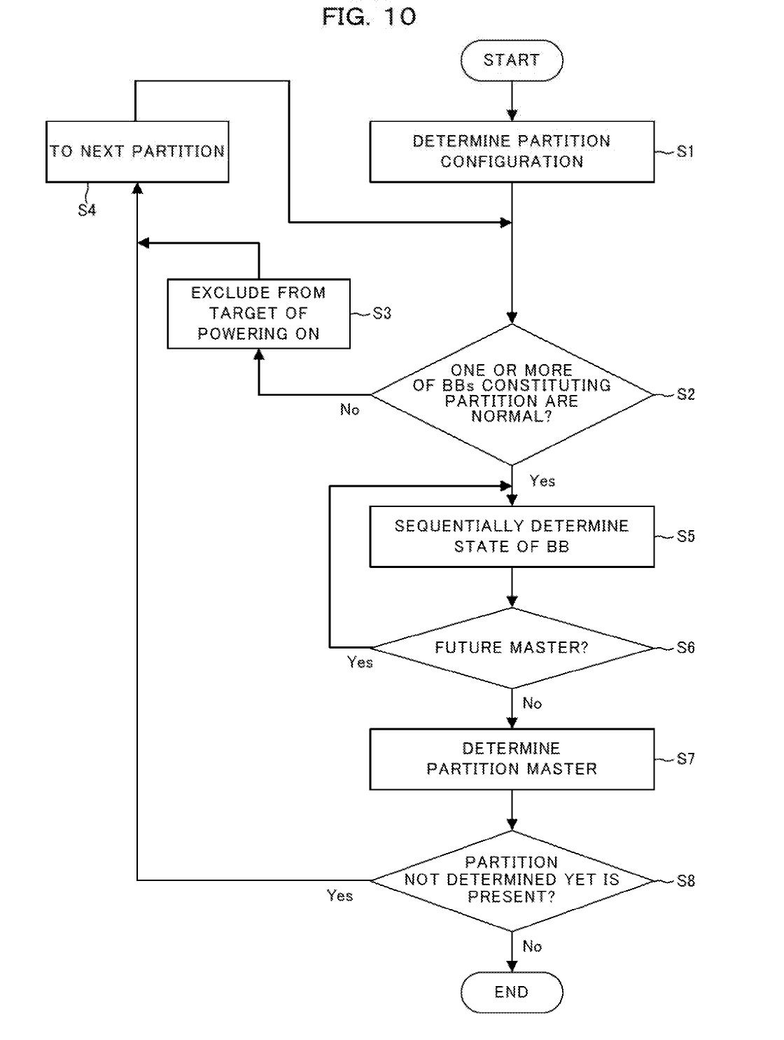

A determination of a partition master in the information processing apparatus 100, which is described above with reference to FIG. 3, will now be described with reference to a flow diagram (Steps S1-S8) in FIG. 10.

The selector 111 of the master BB 1 determines the partition configuration of each partition 10 by referring to the configuration information 202 and the failure information 203 (Step S1).

The selector 111 of the master BB 1 determines whether one or more of the BBs constituting a partition 10 are normal (Step S2)

When none of the BBs constituting the partition 10 is normal (see No route in Step S2), the control instructor 113 of the master BB 1 excludes the BB(s) 1 belonging to the partition 10 from the target of powering on (step S3).

The selector 111 of the master BB 1 changes the target of the determination to the next partition (step S4) and the process returns to step S2.

In step S2, when one or more of the BBs constituting the partition 10 are normal (see Yes route in Step S2), the selector 111 of the master BB 1 sequentially determines the respective states of the BBs 1 belonging to the partition 10 (Step S5).

The selector 111 of the master BB 1 determines whether BB 1 is a future master (Step S6)

When the BB 1 is the future master (see Yes route in Step S6), the process returns to step S5.

In contrast, when the BB 1 is not the future master (see No route in Step S6), the selector 111 of the master BB 1 determines the BB 1 undergoing the determination to be the partition master (Step S7).

The selector 111 of the master BB 1 determines whether a partition 10 not determining the partition master thereof is not determined yet is present (Step S8)

When a partition 10 not determining the partition master thereof yet is present (see Yes route in Step S8), the process moves to Step S4.

In contrast, when a partition 10 not determining the partition master thereof yet is not present (see No route in Step S8), the process ends.

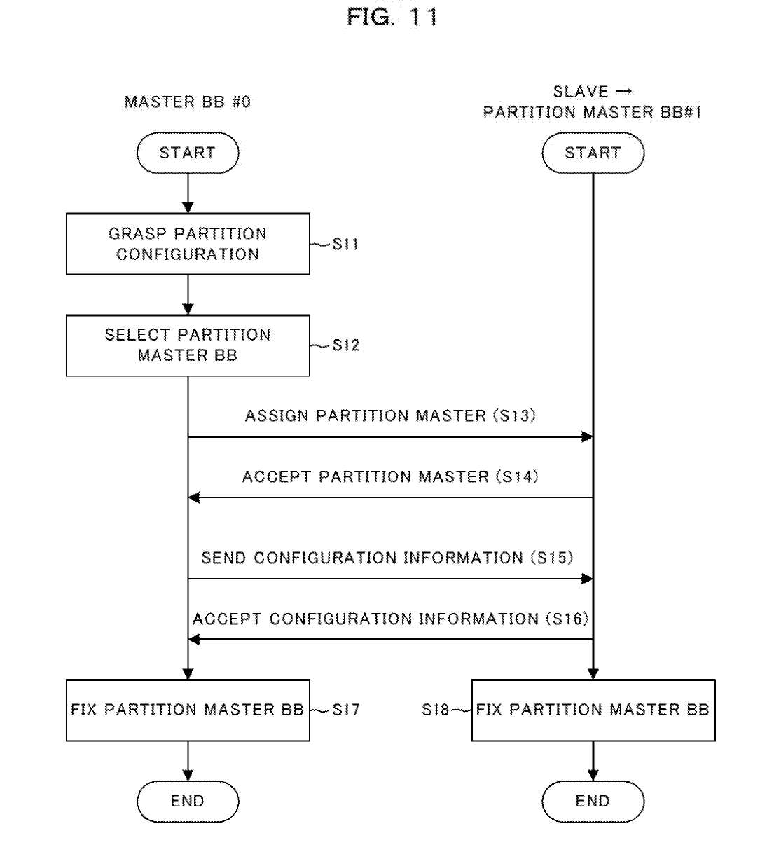

Here, description will now be made in relation to setting of a partition master in the information processing apparatus 100 of FIG. 3 with reference to the flow diagram (Steps S11-S18) in FIG. 11.

The selector 111 of the master BB #0 grasps the partition configuration by referring to the configuration information 202 (Step S11).

The selector 111 of the master BB #0 selects a BB 1 (in the example of FIG. 11, the BB #1) that is to be function as the partition master (Step S12).

The selector 111 of the master BB #0 assigns the selected BB #1 to the partition master (Step S13).

The selector 111 of the BB #1, which receives the assignment to the partition master, transmits a notification of acceptance of the partition master to the master BB #0 (Step S14).

The selector 111 of the master BB #0 transmits the configuration information 202 to the BB #1, which has transmitted the notification of acceptance of the partition master (Step S15). The configuration information 202 to be transmitted to the BB #1 may be limited to the information of the BB(s) 1 in the partition #1, to which the BB #1 belongs to. This makes the BB #1 possible to recognize the BB(s) 1 that the BB #1 is to control.

Upon receipt of the configuration information 202, the BB #1 transmits notification of acceptance of the configuration information 202 to the master BB #0 (Step S16)

The BB #0 and the BB #1 determines the partition master BB 1 (Steps S17 and S18), and the process ends.

Through the above process, the BB #1, which has functioned as a slave, comes to function as the partition master.

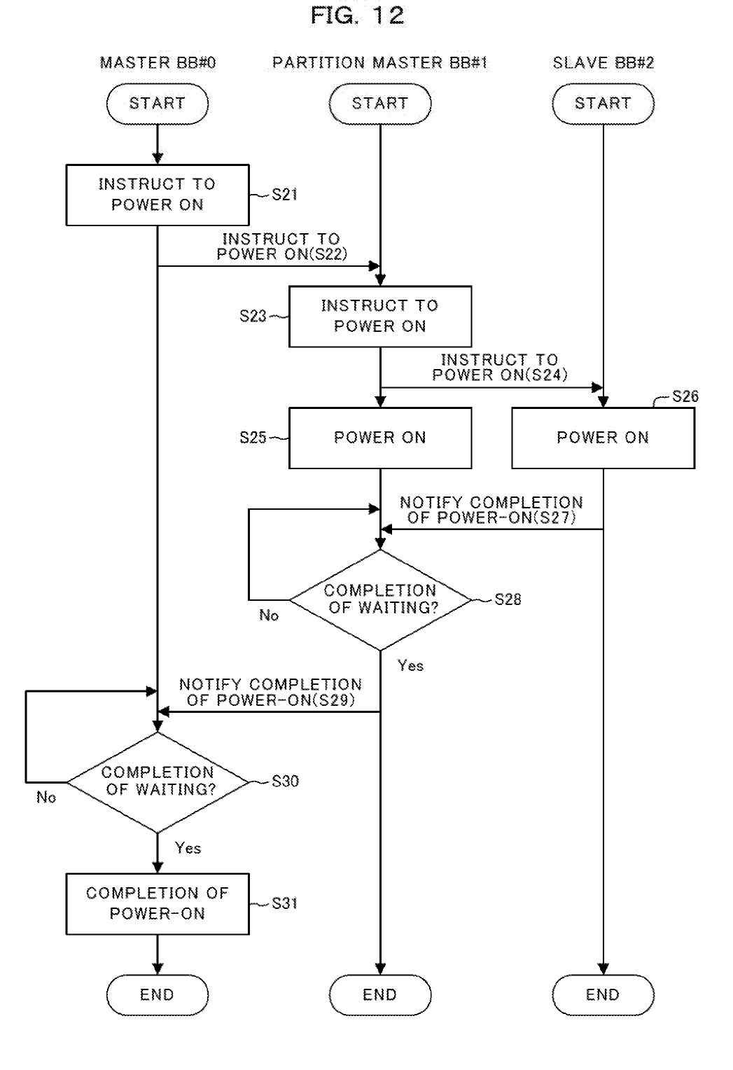

Here, description will now be made in relation to powering on in the information processing apparatus 100 of FIG. 3 along the flow diagram (Steps S21-S31) in FIG. 12.

In the example of FIG. 12, the BB #0 functions as the master, the BB #1 functions as the partition master, and the BB #2 functions as a slave. The BB #1 and the BB #2 belong to the same partition 10.

The control instructor 113 of the master BB #0 issues an instruction to power on to the partition master BB #1 (Steps S21 and S22)

The control instructor 113 of the partition master BB #1 issues an instruction to power on to the slave BB #2 (Steps S23 and S24).

The control processors 112 of the BB #1 and BB #2 power on their own BBs 1 (Steps S25 and S26).

After the powering on BB #2 is completed, the waiting processor 114 of the slave BB #2 notifies the partition master BB #1 that the powering on of the BB #2 is completed (Step S27) and then the process in the slave BB #2 ends.

The waiting processor 114 of the partition master BB #1 determines whether the waiting in the partition 10 is completed (Step S28).

When the waiting is not completed yet (see No route in Step S28), the process of Step S28 is repeated.

In contrast, when the waiting is completed (see Yes route in Step S28), the waiting processor 114 of the partition master BB #1 notifies the master BB #0 that the powering on in the partition 10 is completed (Step S29). Then, the process in the partition master #1 ends.

The waiting processor 114 of the master BB #0 determines whether the waiting in the entire information processing apparatus 100 is completed (Step S30)

When the waiting is not completed yet (see No route in step S30), the process of Step S30 is continued.

In contrast, when the waiting is completed (see Yes route in Step S30), the waiting processor 114 of the master BB #0 recognizes that the powering on the entire information processing apparatus 100 is completed (Step S31), and the process ends.

The controller 110 of the master BB 1 controls each of the multiple partitions 10 as the above, and the controller 110 of each partition master BB 1 controls the partition 10 that the own BB 1 belongs to.

This makes it possible to efficiently control each partition 10.

Specifically, the communication amount between the master BB 1 and the slave BB 1 can be reduced, which allows a rapid sequence control that is accomplished in a short time.

Since the partition master BB1 is set for each partition 10, operation such as powering on and off the system can be freely carried out regardless of the hardware architecture of each BB 1 belonging to a partition 10.

Furthermore, setting of the partition master BB 1 and the slave BB 1 eliminates the need for the master BB 1 to be annoyed by a procedure of controlling the hardware. Even when the system scale is to be expanded, the system can be designed such that the procedure of powering on and off is different with each BB 1. Consequently, the hardware dependence in the sequence control can be reduced.

Even when the master BB 1 is disabled due to failure or other reasons while the system is starting, the system starting can be accomplished through activation of the system in a unit of a partition 10.

Upon a receipt of a control instruction from the master BB 1, the control instructor 113 of the partition master BB 1 transmits the control instruction to the BB(s) 1 belonging to the same partition 10 as that of the partition master BB 1. The waiting processor 114 of the partition master BB 1 receives information indicating that the control carried out in response to the control instruction is completed from each of the other BBs 1. The waiting processor 114 of the partition master BB 1 notifies the master BB 1 that the control carried out in response to the control instruction is completed in the partition 10 that the partition master BB 1 belongs to.

This can reduce the communication amount between the partitions 10, which allows a rapid sequence control that is accomplished in a short time.

The selector 111 of the master BB 1 selects a partition master BB 1 from multiple BBs 1 belonging to a partition different from the partition 10 that the master BB 1 belongs to. Specifically, the selector 111 of the master BB 1 selects, as the partition master BB 1, a BB 1 except for the BB 1 which will take over the function of the master BB 1 when a failure occurs in the master BB 1.

Thereby, a partition master BB 1 can be easily selected.

### (C) Others

The technique disclosed herein is not limited to the foregoing embodiment, and various changes and modifications can be suggested without departing from the scope of the embodiment. Each configuration and each process of the foregoing embodiment can be selected, omitted, and appropriately combined according to the need.

The information processing apparatus disclosed herein can efficiently controls each partition.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a plurality of partitions;
a first controlling device belonging to a first partition among the plurality of partitions; and
a second controlling device belonging to a second partition among the plurality of partitions, wherein
the first controlling device comprises a first processor configured to control the plurality of partitions, and
the second controlling device comprises a second processor configured to control the second partition.

2. The information processing apparatus according to claim 1, wherein the second processor is further configured to:
send, upon receiving a controlling instruction from the first processor, the controlling instruction to one or more third controlling devices belonging to the second partition;
notify, upon receiving information indicating that control based on the controlling instruction is completed from each of the third controlling devices, the first processor of completion of the control based on the controlling instruction in the second partition.

3. The information processing apparatus according to claim 1, wherein the first processor is further configured to select the second controlling device among a plurality of controlling devices belonging to the second partition except for a prospective controlling device that is to take over a function of the first controlling device in a case where a failure occurs in the first controlling device.

4. The information processing apparatus according to claim 2, wherein the first processor is further configured to select the second controlling device among a plurality of controlling devices belonging to the second partition except for a prospective controlling device that is to take over a function of the first controlling device in a case where a failure occurs in the first controlling device.

5. A controlling device belonging to a second partition different from a first partition comprising a master controlling device that manages a plurality of partitions among the plurality of partitions, the controlling device including a processor configured to control the second partition.

6. The controlling device according to claim 5, wherein the processor is further configured to:
send, upon receiving a controlling instruction from the master controlling device, the controlling instruction to one or more third controlling devices belonging to the second partition;
notify, upon receiving information indicating that control based on the controlling instruction is completed from each of the third controlling devices, the master controlling device of completion of the control based on the controlling instruction in the second partition.

7. The controlling device according to claim 5, wherein the controlling device is one controlling device among a plurality of controlling devices belonging to the second partition except for a prospective controlling device that is to take over a function of the master controlling device in a case where a failure occurs in the master controlling device.

8. The controlling device according to claim 6, wherein the controlling device is one controlling device among a plurality of controlling devices belonging to the second partition except for a prospective controlling device that is to take over a function of the master controlling device in a case where a failure occurs in the master controlling device.

9. A non-transitory computer-readable recording medium having stored therein a program that instructs a computer included in a controlling device to execute a process comprising:
controlling a second partition different from a first partition comprising a master controlling device that manages a plurality of partitions among the plurality of partitions.

10. The non-transitory computer-readable recording medium according to claim 9, wherein the process further comprises:
sending, upon receiving a controlling instruction from the master controlling device, the controlling instruction to one or more third controlling devices belonging to the second partition;
notifying, upon receiving information indicating that control based on the controlling instruction is completed from each of the third controlling devices, the master controlling device of completion of the control based on the controlling instruction in the second partition.

11. The non-transitory computer-readable recording medium according to claim 9, wherein the controlling device is one controlling device among a plurality of controlling devices belonging to the second partition except for a prospective controlling device that is to take over a function of the master controlling device in a case where a failure occurs in the master controlling device.

12. The non-transitory computer-readable recording medium according to claim 10, wherein the controlling device is one controlling device among a plurality of controlling devices belonging to the second partition except for a prospective controlling device that is to take over a function of the master controlling device in a case where a failure occurs in the master controlling device.
